(19) United States
(12) Patent Application Publication
(10) Pub. No.: US 2009/0231685 A1
(43) Pub. Date: Sep. 17, 2009

(54) OPTICAL AMPLIFIER FOR TUNING TRANSMISSION TIME OF OPTICAL SIGNAL

(76) Inventors: Jyehong CHEN, Hsinchu (TW); Wei-Che Kao, Hsinchu (TW); Peng-Chun Peng, Hsinchu (TW); Chun-Ting Lin, Hsinchu (TW); Po Tsung Shih, Hsinchu (TW); Sien Chi, Hsinchu (TW)

Correspondence Address: Muncy, Geissler, Olds & Lowe, PLLC, P.O. BOX 1364, FAIRFAX, VA, 22038-1364, US

(21) Appl. No.: 12/189,296

(22) Filed: Aug. 11, 2008

(30) Foreign Application Priority Data
Mar. 11, 2008 (TW) 97108529

(51) Int. Cl. H01S 3/09; H01S 3/00; H01S 3/14

(52) U.S. Cl. 359/341.3; 359/341.1; 359/341.5

(57) ABSTRACT

The present invention relates to a technique for tuning the transmission time of optical signal, which adopts an optical amplifier with a bending structure for enhancing the tunable time of optical signal. The effect of tunable time of optical signal can be achieved by adjusting the gain of the optical amplifier.

### BACKGROUND OF THE INVENTION

1. Field of the Invention

The present invention relates to an optical amplifier, more particularly to an optical amplifier for tuning the transmission time of optical signal.

2. Description of the Prior Art

Optical fiber amplifiers (OFA) comprising optical fiber doped with rare earth, e.g. erbium (Er), neodymium (Nd), praseodymium (Pr), as the major component have been commonly used recently.

On the other hand, techniques for tuning the transmission time of optical signal have been the focus point and can be applied in systems such as optical signal synchronization, all-optical signal processing, all-optical network, all-optical buffer, all-optical storage, phased array radar, and etc.

In the U.S. Pat. No. 7,212,695, the tunable time of optical signal is achieved by adopting a multi-path electro-optical component. As an optical signal travels along paths of different length, its time delay varies, and the tunable time of optical signal can be achieved. Therefore, it shows the great value of products for tunable time of optical signal.

In the U.S. Pat. No. 7,251,395, the tunable time of optical signal is achieved by winding an optical fiber on a round disc. As an optical signal travels along paths of different length, its time delay varies, and the tunable time of optical signal can be achieved.

In the U.S. Pat. No. RE038,809, the tunable time of optical signal is achieved by stacking a birefringent crystal. Because the altered bias makes two light beams with orthogonal polarization deviate in different directions, the light beams travels along paths of different lengths, and the tunable time of optical signal can be achieved. However, the disadvantage of this system is requirement of high stability and assembling difficulty.

Y. K. Yeo et al (IEEE Photonics Technology Letters, vol. 16, pp. 2559-2561, 2004.) adopt multiple electro-optical switches for controlling the optical path to achieve the effect of tunable time of optical signal but thus have a very large system with complicated control.

Hence, the conventional methods for tuning the transmission time of optical signal must adopt machine-controlling methods to adjust the optical path for shorter or longer paths to achieve the effect of tunable time of optical signal. However, these methods require tremendous control time and cost of optical paths.

### SUMMARY OF THE INVENTION

To solve the above-mentioned problem, one objective of the present invention is to provide an optical amplifier for tuning transmission time of optical signal, which adopts an optical amplifier with a bending structure to enhance the tunable time of optical signal. The transmission time of optical signal can be achieved by adjusting the gain of the optical amplifier.

To achieve the above-mentioned objective, one embodiment of the present invention provides an optical amplifier, including a bending structure receiving a first optical signal and a pump energy, wherein the pump energy generates a gain of the first optical signal in the optical amplifier, amplifies the first signal and outputs a second optical signal, and the bending structure of the optical amplifier is arc-shaped for tuning the transmission time of the second optical signal.

To achieve the above-mentioned objective, another embodiment of the present invention provides an optical fiber amplifier for tuning the transmission time of optical signal, including a laser diode emitting a first light source; a signal generator receiving the first light source; an electro-optical modulator (EOM) connected to the signal generator and modulating the first light source into a sine wave optical signal; a one-to-two optical fiber modulator connected to the electro-optical modulator and receiving the sine wave optical signal; a wavelength dependent optical fiber coupler connected to the one-to-two optical fiber coupler and receiving the sine wave optical signal, wherein the wavelength dependent optical coupler further receives a second light source and generates a third light source; and a bending optical path component connected to the wavelength dependent optical fiber coupler and receiving the third light source, wherein the bending optical path component is an optical fiber doped with rare earth and is arc-shaped for tuning the transmission time of the third light source.

Other advantages of the present invention will become apparent from the following description taken in conjunction with the accompanying drawings, which are set forth by way of illustration and example, to certainly embody the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a diagram showing a bending optical waveguide according to one embodiment of the present invention;

FIG. 2 is a schematic diagram showing an optical fiber amplifier 10 for tuning the transmission time of optical signal according to one embodiment of the present invention; and

FIG. 3 is an optical signal chart observed by an oscilloscope.

### DESCRIPTION OF THE PREFERRED EMBODIMENT

The detailed explanation of the present invention is described as following. The described preferred embodiments are presented for purposes of illustrations and description, and they are not intended to limit the scope of the present invention.

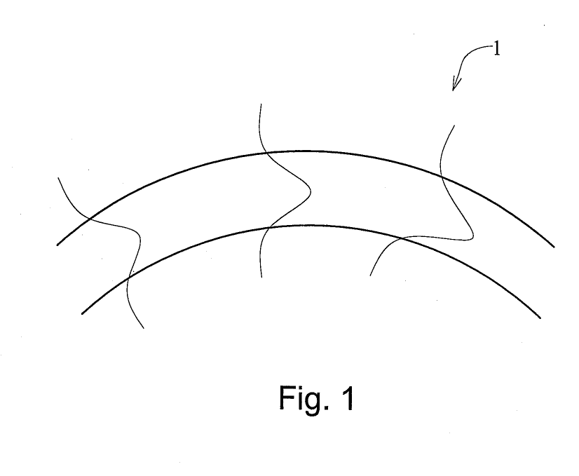

FIG. 1 is a diagram showing a bending optical waveguide according to one embodiment of the present invention. The bending optical waveguide is formed with an optical amplifier 1 with a bending structure, and receives an optical signal and a pump energy. The pump energy generates the gain of the optical signal in the optical amplifier, amplifies and outputs the optical signal, whereas the pump energy may be light energy or electric energy. The optical amplifier is arc-shaped for tuning the transmission time of received optical signal, therefore provides the function of tunable time of optical signal.

The aforesaid optical amplifier may be an optical fiber amplifier or a semiconductor optical amplifier.

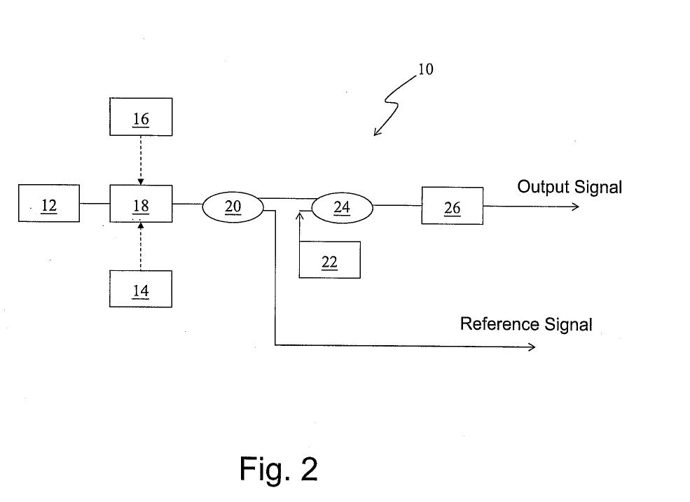

FIG. 2 is a schematic diagram showing an optical fiber amplifier 10 for tuning the transmission time of optical signal according to one embodiment of the present invention. A laser beam emitted from a laser diode 12, via a wavelength dependent optical fiber coupler 24, enters an erbium-doped optical fiber 26, and transmits therewith, wherein the erbium-doped optical fiber is arc-shaped.

Referring to FIG. 2 again, the optical fiber amplifier 10 of this embodiment further includes a signal generator 16 used for receiving the laser beam emitted from the laser diode 12; an electro-optical modulator (EOM) 18 electrically connected to the signal generator 16 and used for modulating the laser beam emitted from the laser diode 12 into a sine wave optical signal; a one-to-two optical fiber coupler 20 receiving the sine wave optical signal and inputting it into the associated optical fiber coupler 24; a DC bias providing a direct current bias to the EOM 18; and a pump diode 22 emitting the laser beam inputting into erbium-doped optical fiber 26 via associated optical coupler 24 to pump the erbium-doped optical fiber 26, wherein the wavelength of the light source generated by the pump diode 22 is 980 nm or 1480 nm.

According to the above description, the velocity v_{g} of the optical signal passing through a waveguide can be defined as equation (1):

$${v}_{g} = \frac{c}{{n}_{g}} \qquad ( 1 )$$

where n_{g} is a group reflective index, c is the speed of light. According to the coherent population oscillations, n_{g} can be controlled by adjusting the gain of optical amplifier; therefore, the tunable time of optical signal can be achieved by adjusting the gain of optical amplifier.

As for normal optical waveguide amplifiers, however, after the signal is input, the front end can have more gain of optical signal because of less signal, but the back end has less or even no gain due to the optical signal amplified at the front. The tunable time of optical signal would be limited according to coherent population oscillations. The present invention adopts a bending optical waveguide, as shown in FIG. 1, in which, while the optical signal is propagated in the optical waveguide amplifier, the signal is not only amplified but also attenuated due to the bending optical waveguide. As a result, while the optical signal is propagated to the back end of the optical amplifier, the optical signal is weaker but has more gain of optical signal; therefore, the tunable time of optical signal can be greatly enhanced.

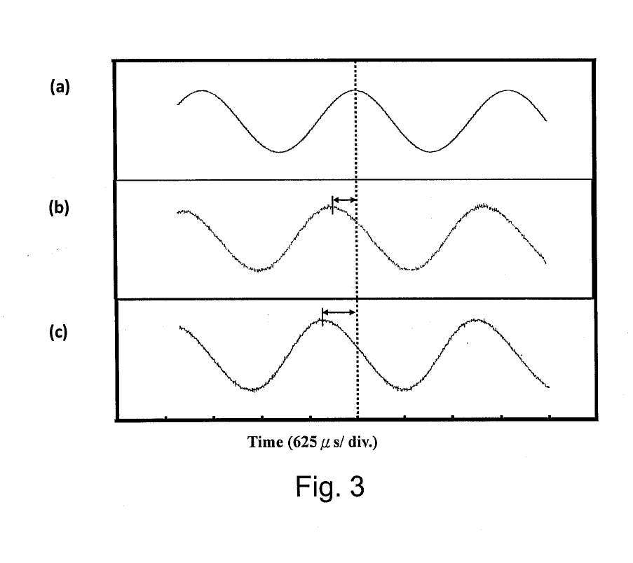

According to the schematic diagram shown in FIG. 2, in one embodiment using erbium-doped optical fiber amplifier, the time diagram of output signal of optical amplifiers with and without a bending loss structure are compared. At first, an optical carrier wave at wavelength 1550 m is generated by a laser diode and modulated into a sine wave signal by an EOM 18. Then through the one-to-two optical coupler 20, one way is regarded as the reference signal, and the other way enters the erbium-doped optical fiber amplifier 26 via the wavelength dependent optical fiber coupler 24. The variation of output optical signal is compared between the erbium-doped optical fiber with bending loss (whose bending diameter is 1.5 cm) and the erbium-doped optical fiber without bending loss. FIG. 3 shows the optical signal chart observed by an oscilloscope, where (a) is the reference signal; (b) is the output signal of erbium-doped optical fiber without bending loss; and (c) is the output signal of erbium-doped optical fiber with bending loss. In the same condition observed by the oscilloscope, it is found that the transmission time of for optical signal passing through the erbium-doped optical fiber with bending loss is 1.4× greater than through erbium-doped optical fiber without bending loss.

Furthermore, in another embodiment, the erbium-doped optical fiber may be substituted with a praseodymium-doped optical fiber, and the wavelength of the optical carrier wave from laser diode is 1310 nm. Both the erbium-doped optical fiber and praseodymium-doped optical fiber are arc-shaped.

The present invention for tuning the transmission time of optical signal can be applied in systems such as optical signal synchronization, all-optical signal processing, all-optical network, all-optical buffer, all-optical storage, phased array radar, and etc. The present invention can achieve the effect of tunable time of optical signal and is of great advance.

The present invention adopts a bending optical waveguide amplifier to enhance the tunable time of optical signal. The time of optical signal can be controlled by varying the gain of optical amplifier without adjusting the optical path. Besides, the present invention makes a breakthrough of the gain saturation characteristics of the optical amplifiers, and the tunable time of optical signal can be enhanced with a bending optical waveguide.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. An optical amplifier for tuning transmission time of optical signal, comprising:
an optical amplifier with a bending structure receiving a first optical signal and a pump energy, wherein the pump energy generates a gain of the first optical signal in the optical amplifier, amplifies the first signal and outputs a second optical signal, and the bending structure of the optical amplifier is arc-shaped for tuning the transmission time of the second optical signal.

2. The optical amplifier as claimed in claim 1, wherein the wavelength of the first optical signal is about 1550 nm or 1310 nm.

3. The optical amplifier as claimed in claim 1, wherein the pump energy is light energy or electrical energy.

4. The optical amplifier as claimed in claim 1, wherein the optical amplifier is an optical fiber amplifier or a semiconductor optical amplifier.

5. An optical fiber amplifier for tuning transmission time of optical signal, comprising:
a laser diode emitting a first light source;
a signal generator receiving the first light source;
an electro-optical modulator (EOM) connected to the signal generator and modulating the first light source into a sine wave optical signal;
a one-to-two optical fiber coupler connected to the electro-optical modulator and receiving the sine wave optical signal;
a wavelength dependent optical fiber coupler connected to the one-to-two optical fiber coupler and receiving the sine wave optical signal, wherein the wavelength dependent optical coupler further receives a second light source and generates a third light source; and
a bending optical path component connected to the wavelength dependent optical fiber coupler and receiving the third light source, wherein the bending optical path component is an optical fiber doped with rare earth and is arc-shaped for tuning the transmission time of the third light source.

6. The optical fiber amplifier as claimed in claim 5, wherein the wavelength of the optical carrier wave of laser diode is about 1550 nm or 1310 nm.

7. The optical fiber amplifier as claimed in claim 5, wherein the second light source is generated by a pump diode, and the wavelength of the second light source is about 980 nm or 1480 nm.

8. The optical fiber amplifier as claimed in claim 5, the bending optical path component is an erbium-doped optical fiber or a praseodymium-doped optical fiber.
